(19) United States
(12) Patent Application Publication
(10) Pub. No.: US 2019/0193840 A1
(43) Pub. Date: Jun. 27, 2019

(54) Optimally Stabilized Multi Rotor Aircraft

(71) Applicants: Stephen Burtt, Milwaukie, OR (US); Jim Campbell, Willsonville, OR (US); Lawrence Dennis, Portland, OR (US)

(72) Inventors: Stephen Burtt, Milwaukie, OR (US); Jim Campbell, Willsonville, OR (US); Lawrence Dennis, Portland, OR (US)

(21) Appl. No.: 16/268,825

(22) Filed: Feb. 6, 2019

Related U.S. Application Data
(63) Continuation-in-part of application No. 15/390,427, filed on Dec. 23, 2016.

(51) Int. Cl. B64C 17/06; B64C 39/02

(52) U.S. Cl. CPC B64C 17/06; B64C 39/024; B64C 2201/165; B64C 2201/108; B64C 2201/027

(57) ABSTRACT

A multi horizontal rotor drone having a propulsion unit coupled to a payload housing by a multi-axial gimbal assembly. The centers of mass of each of these three components resides at a common point that also coincides with the pitch and roll axes (and optionally the yaw axis) of the gimbal assembly's rotational orientations. The propulsion unit has the minimal operational mass necessary while the majority of the drone's mass is located onto the payload housing. With this arrangement, the payload housing can be stabilized on its center of gravity independent of the roll, pitch and yaw changes undergoing by the propulsion unit, during the drone's flight.

### CLAIM FOR DOMESTIC PRIORITY

This application incorporates in its entirety, and claims the benefit of priority from co-owned, pending U.S. Utility patent application Ser. No. 15/390,427 filed Dec. 23, 2016 and entitled “Multi-Rotor Aircraft Including a Split Dual Hemispherical Attachment Apparatus for Virtual Reality Content Capture and Production.”

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to aerial vehicle operation, although it applies to manned aircraft the description herein is directed more particularly to multi horizontal rotor drone suspension technology.

### BACKGROUND

A drone, in a technological context, is an unmanned aerial vehicle (UAV) or an unmanned aircraft system (UAS). It essentially is a flying robot that is remotely controlled or flown via software-controlled flight plans in their onboard microprocessor systems with input from onboard sensors and GPS. While conventional aircraft style airplanes are commonly referred to as drones, these are used primarily by the military and see little, commercial use. The helicopter style, multi horizontal rotor aircrafts, also called drones are much cheaper to purchase, easy to scale down, require little regulatory licensing and oversight and more importantly—are easy to learn to operate. For these reasons, this style of drone has found a niche in a plethora of commercial applications including aerial photography and package delivery. However, these are not without downfalls.

Stabilization of the load and stabilization of the propulsion unit are huge problems for multi horizontal rotor drones. When such a conventional drone flies into wind sheers, updrafts, thermals and otherwise shifting winds, or makes a direction or elevation change, the individual rotors adjust their speeds to compensate and minimize the tilting of the propulsion unit. However, due to the inherent time lag between motion/position sensors and the initiation of the corresponding corrective rotor action, coupled with the mass of the body of the drone as well as inertial load forces when the drone changes direction, the drone is jostled around. This is troublesome when using the drone to shoot aerial videos or to deliver fragile goods. It also makes it difficult to land the drone with its propulsion unit horizontal.

Simply stated, with current drone designs the mass adjusted in accomplishing rotor positional changes (for alteration in direction and elevation) is too large. This retards the response time, tilts the payload longer than necessary, and wastes energy.

Henceforth, a multi horizontal rotor drone able to stabilize the propulsion unit and the payload housing quicker and with less agitation while boosting the drone's energy efficiency would fulfill a long felt need in the industry. This new invention utilizes and combines known and new technologies in a unique and novel configuration to overcome the aforementioned problems and accomplish this.

### BRIEF SUMMARY

In accordance with various embodiments, a multi horizontal rotor drone with a quicker, smoother method of stabilizing its propulsion unit and payload housing is provided.

In one aspect, multi horizontal rotor drone is provided wherein the gimbal assembly stabilizes the propulsion unit and thus the rotor positions of the drone rather than the payload housing.

In another aspect, multi horizontal rotor drone wherein the lighter propulsion unit moves independent of the heavier payload housing (the rest of the body and its load) to allow for quicker rotor stabilization actions.

In yet another aspect, a multi horizontal rotor drone with a reduced mass propulsion unit coupled to the payload housing by a tri-axial gimbal assembly.

In yet a final aspect, a multi horizontal rotor drone where the gimbal controller can level the propulsion frame prior to take off from a level or non-level launching surface.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a right side perspective view of the multi rotor drone;

FIG. 2 is a left side perspective view of the multi rotor drone;

FIG. 3 is a top perspective view of the propulsion unit;

FIG. 4 is a side perspective view of the payload housing;

FIG. 5 is a top perspective cutaway view of the payload housing;

FIG. 6 is a top perspective view of the gimbal assembly showing the three axis of a left hand orientation Cartesian Coordinate system;

FIG. 7 is a top perspective view of the drone showing the three axis of a left hand orientation Cartesian Coordinate system;

FIGS. 8 and 9 are front views of the multi rotor drone in different payload stabilized configurations;

FIG. 10 is bottom perspective of the alternate embodiment drone;

FIG. 11 is a top perspective cut away view of the alternate embodiment drone showing two axes of a left hand orientation Cartesian Coordinate system; and

FIG. 12 is a bottom perspective view of the alternate embodiment drone showing the two axes of a left hand orientation Cartesian Coordinate system.

### DETAILED DESCRIPTION OF certain embodiments

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. It should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein, the term “drone” refers to an unmanned aircraft.

As used herein, the term “propulsion unit” refers to the lifting system of the drone made of motor assemblies, rotors, boom arms, a motor controller with internal or external IMU sensor units, and the propulsion unit frame that operationally and structurally connects them. The propulsion frame is coupled to the first portion (the reactive portion) of the gimbal assembly.

As used herein the term “gimbal assembly” refers to a device placed between two bodies that allow the two bodies to remain structurally connected yet each have a freedom of rotational movement for roll and pitch and depending on the gimbal mechanism's design, optionally yaw. The gimbal assembly generally, does not allow the two bodies to have any freedom for translational movement. The gimbal assembly only regulates one of the bodies' orientation through rotation. The two bodies still move as one unit for the up/down (heave), left/right (sway) and forward/back (surge) translations. The gimbal assembly has at least two gimbal motors, a tri-axial frame, a gimbal controller with internal or external IMU sensor units, a battery and the associated operational wiring.

As used herein, the term “payload housing” refers to the remainder of the operational drone. i.e. that which is coupled to the propulsion unit through the second portion (the non-reactive portion) of the gimbal mechanism and all of the operational components it supports. It includes the physical structure to hold the power supply for the gimbal motors, motor assemblies, motor and gimbal controllers, IMU sensors, autopilots, antennas, cameras and payload.

As used herein the term “orientation sensor” refers to any of the types of electronic sensors or combinations thereof that calculate the attitude, angular rates, linear velocity and position of a body relative to a global reference frame. In the preferred embodiment an IMU (Inertial Measurement Units) is used as an orientation sensor. The IMU being made of a combination of a set accelerometers, gyroscopes and optionally magnetometers for each of the pitch, roll and yaw axes.

The current designs of multi horizontal rotor drones, have rigid frames containing the motors assemblies, rotors, motor controller and orientation sensors, autopilot, antennas, and batteries necessitating the entire mass of the flight platform to change position for roll and pitch in response to changing flight conditions. This stabilization is slow, uses more energy than necessary and causes a fallout of conditions detrimentally affecting drone equipment and payload, especially where cameras are involved.

The present invention relates to a novel design for a three component, multi horizontal rotor drone where the lifting system of motors and rotors (a rigid propulsion unit) is separated from the body of the drone (a rigid payload housing) by a tri-axial gimbal assembly (multiple gimbals coupled through a gimbal frame). In this novel design, the centers of mass for the components coincide and resides at the intersection of the pitch, roll and yaw axes of the gimbal assembly 8. All unnecessary mass on the propulsion unit is relocated onto the payload housing, leaving the propulsion unit much lighter than the payload unit.

It is to be noted that this concept of the centers of mass for the components of a manned aircraft (multi rotor or fixed wing style) coinciding and residing at the intersection of the pitch, roll and yaw axes of a gimbal assembly is equally feasible although not discussed in detail herein.

The lighter propulsion unit is the component of the drone that has its orientation independently adjusted by the gimbal assembly to effect changes in pitch, roll and yaw experienced by the heavier payload housing caused by changes in direction, speed and elevation of the propulsion unit or by the entire drone in response to environmental conditions such as wind gusts, wind shear and the like. The payload housing is thus stabilized on its center of gravity and is independent of the roll, pitch and yaw changes undergoing by the propulsion unit, needed to maintain flight.

This reduced mass of the propulsion frame, along with the common centers of mass of the three drone components, shortens stabilization response time, and the energy required to make the rotor alterations as it stabilizes the payload housing for supporting antennas, sensor arrays, cameras, landing gear, packages, and the like. With the payload housing stabilized to a higher degree, there is also an increase in the drone's lift or load capability. It is to be noted that in normal aerial photography there may be numerous different camera utilized such as virtual reality cameras, multi spectral cameras, IR cameras, Optical avoidance cameras, coronal cameras, LIDAR cameras, etc. To maintain the center of mass of the payload housing as discussed above in common with the propulsion unit and the gimbal unit, the additional cameras are placed strategically about the exterior of the payload housing as would be known by one skilled in the art.

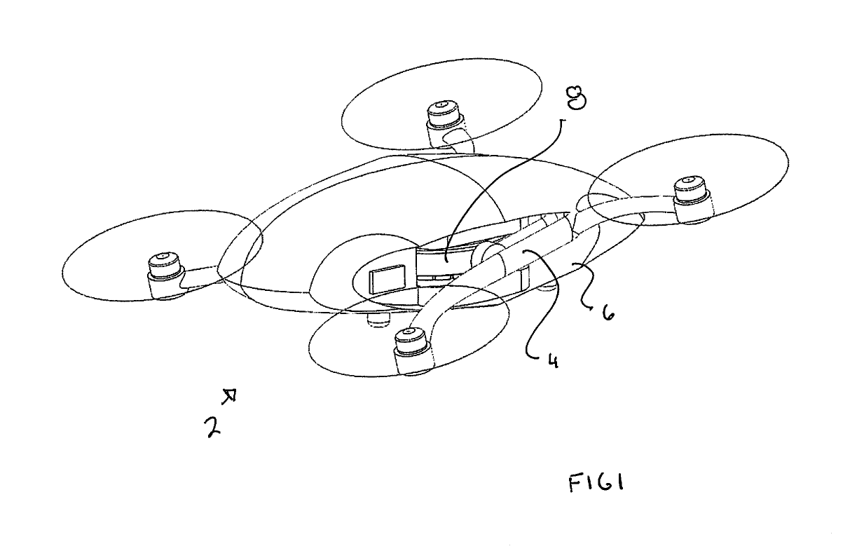

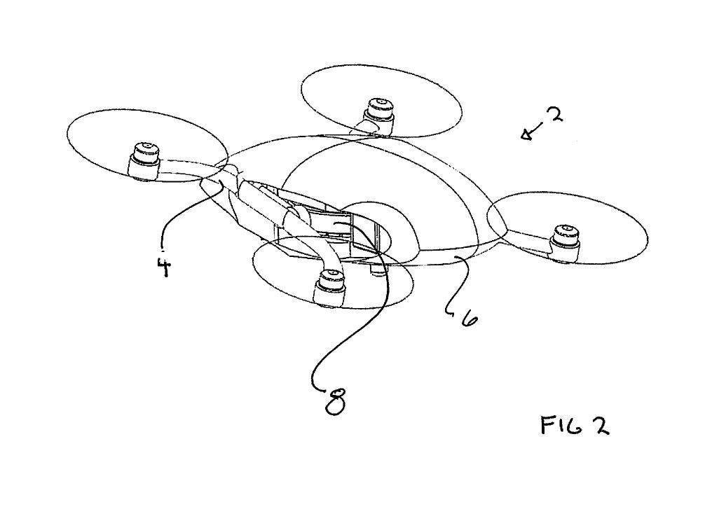

Looking at FIGS. 1 and 2, the multi rotor drone 2 and all its components can best be seen. Although a complex electo-mechanical device, because of minaturization and solid state circuitry it requires but a handfull of components to form an operational drone. The three main structural components of the drone 2 are the propulsion unit 4, the payload housing 6 and a three axis gimbal assembly 8 connecting the propulsion unit 4 and the payload housing 6.

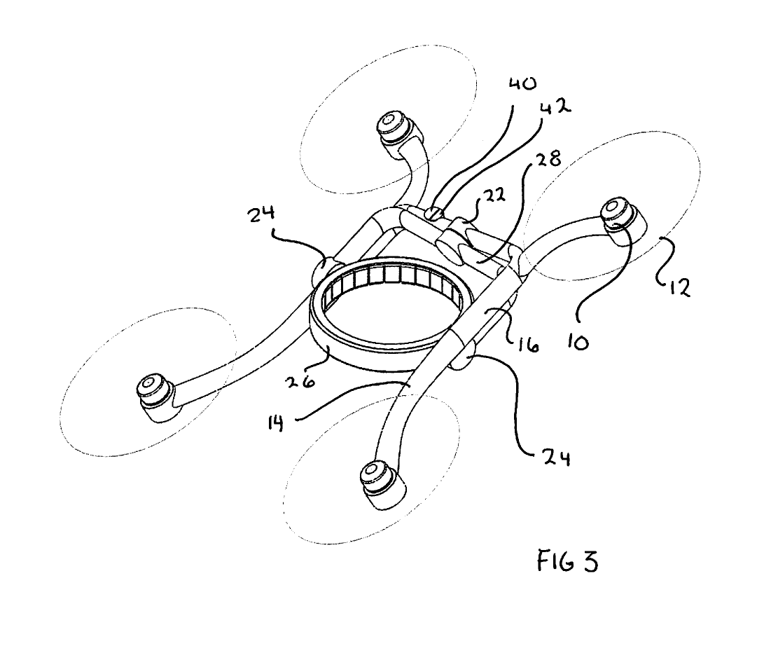

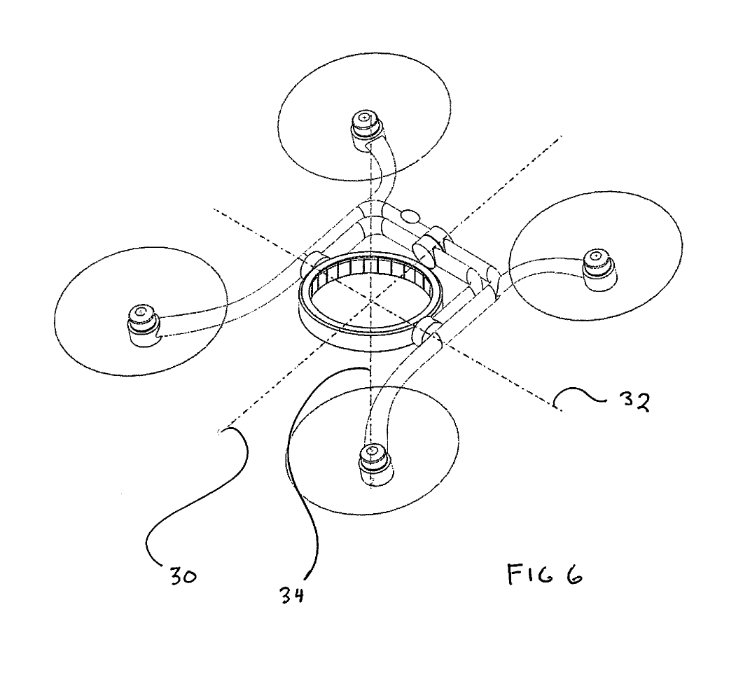

The propulsion unit 4 (FIGS. 3 and 6) has at least three motor assemblies 10 although the preferred embodiment has four motor assemblies 10 operationally coupled to a multi blade rotor 12. The motor assemblies 10 are held in boom arms 14 positioning the rotors 12 a sufficient distance from the other rotors and the payload housing 6 for safety and yet positioned for optimized flight performance. In the preferred embodiment, the two motor assemblies 10 on the right side of the drone 2 have their boom arms 14 rigidly connected together to the right side of the propulsion frame 16. The two motor assemblies 10 on the left side of the drone have their boom arms 14 connected to the left side of the propulsion frame 16. The propulsion frame 18 is connected to the tri-axis gimbal assembly 8. Through the connectivity of the boom arms 14 and the propulsion frame 16 all four motor assemblies 10 are rigidly connected to one another so as to form a planar propulsion unit that pivots about its center of mass. Thus, the four motor assemblies 10 always share a common plane regardless of the direction that their rotors pull the drone 2.

The propulsion unit 4 has a motor controller 40 in operational contact with each of the drone's motor assemblies which may be that may located on the propulsion unit 4 or the payload housing 6. This unit receives signals from the auto pilot 42 or a remote controller that changes the speeds of individual or groupings of motor assemblies to increase the amount of pull the various rotors 12 exert on the drone 2. This causes the drone 2 to change its change position as a translation in the three perpendicular axes. These translations are known as forward/backward (surge), up/down (heave), left/right (sway).

The motor controller 40 receives feedback signals about the propulsion systems orientation from its propulsion IMU sensor/s 42 which may be internal or external to the motor controller. FIG. 3 illustrates a motor controller 40 with an internal propulsion IMU sensor 42, although to lighten the propulsion unit external propulsion IMU sensors 42 may be located about the propulsion unit on the boom arms 14 or propulsion frame 16 and the motor controller located on the payload housing 6.

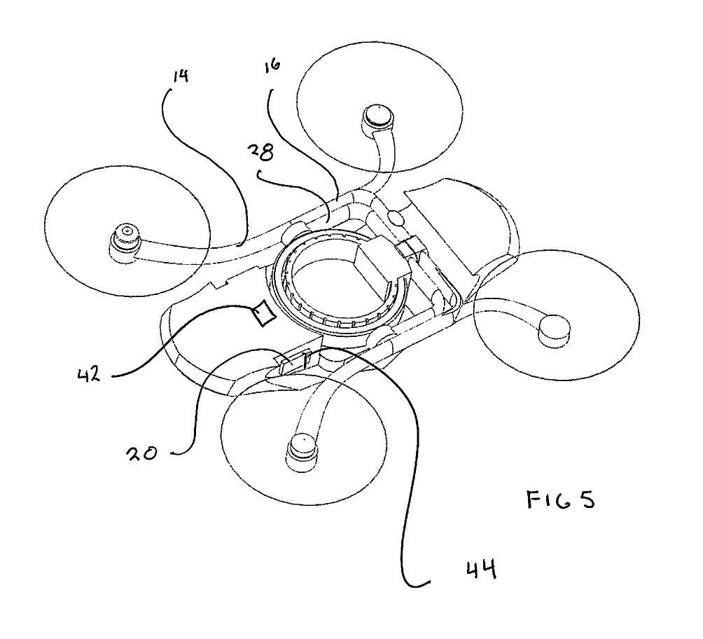

Looking at FIGS. 3, 5 and 6, the tri-axial gimbal assembly 8 compensates for changes in the payload housing orientation through rotation about its three perpendicular axes, often termed yaw (normal axis), pitch (transverse axis), and roll (longitudinal axis). The gimbal assembly 8 resides between, and structurally connects the propulsion unit 4 and the payload housing 6, although it is oriented horizontally within the stabilized payload housing. It has three electric rotational motors—a pitch motor 22, at least one roll motor 24 (although the preferred embodiment has a balanced roll design utilizing two roll motors 24), and a yaw motor 26. These motors are structurally connected to each other by a gimbal frame 28. (It is to be noted that the motor designations of pitch and roll may be interchanged as the pitch and roll axis lie in the same plane but 90 degrees apart.)

The gimbal motors have a first portion and a second portion that rotate clockwise or counterclockwise relative to each other. These three gimbal motors generate low torque values but are capable of extremely fast signal response (rotational movements) from the gimbal controller 20 based on positional data input signals of the payload housing's orientation from the gimbal controller's IMU sensor/s.

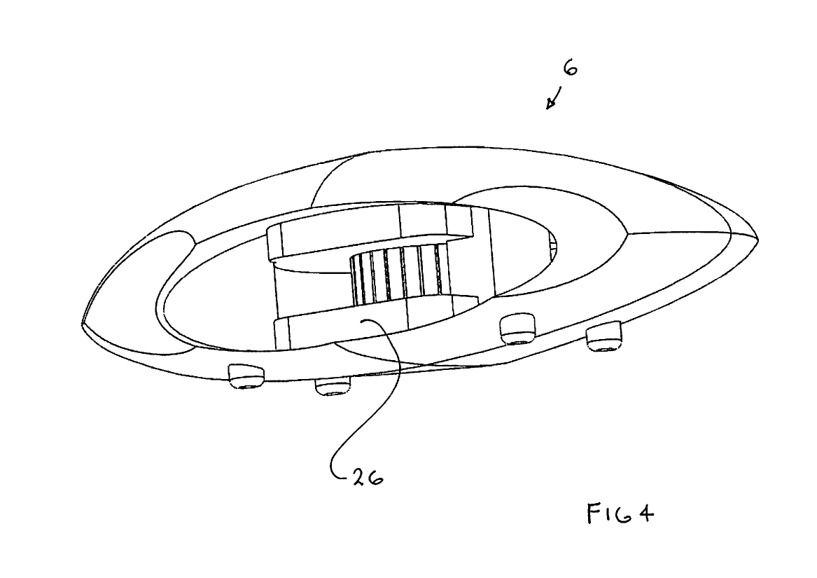

Only one of the gimbal motors (in the preferred embodiment it is the pitch motor 22) is connected to the propulsion unit 4 via the propulsion frame 16. Here, the first portion of the pitch motor 22 is connected to the propulsion frame 16 and the second portion of the pitch motor 22 is connected to the gimbal frame 28. The roll motor 24 has its first portion connected to the gimbal frame 28 and its second portion connected to the first portion of the yaw motor 26. The yaw motor 26 has its first portion connected to the second portion of the roll motor 24 and its second portion connected to the payload housing 6. (FIGS. 4 and 1)

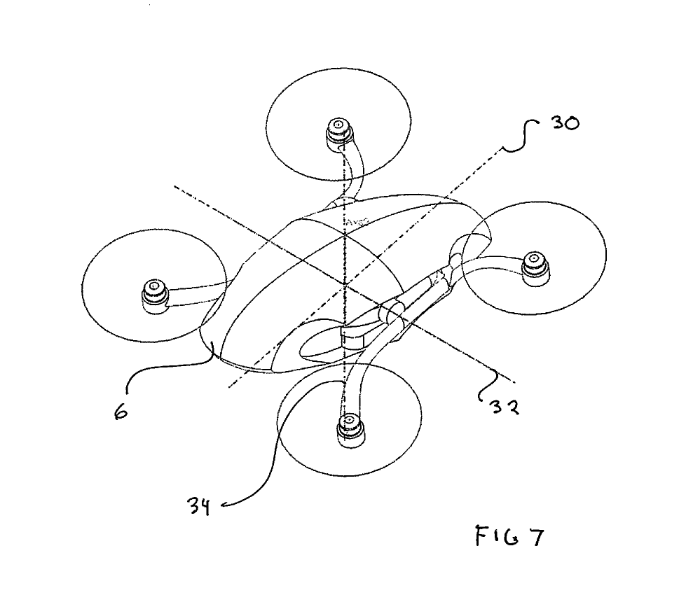

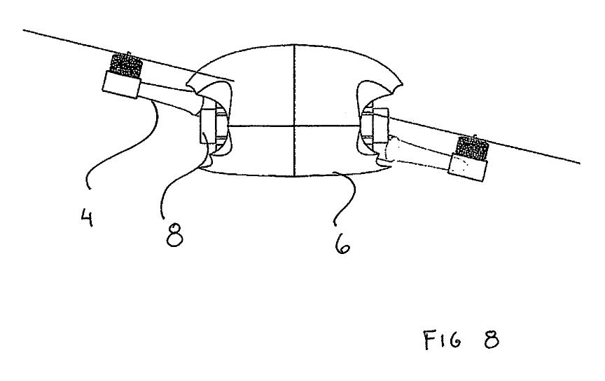

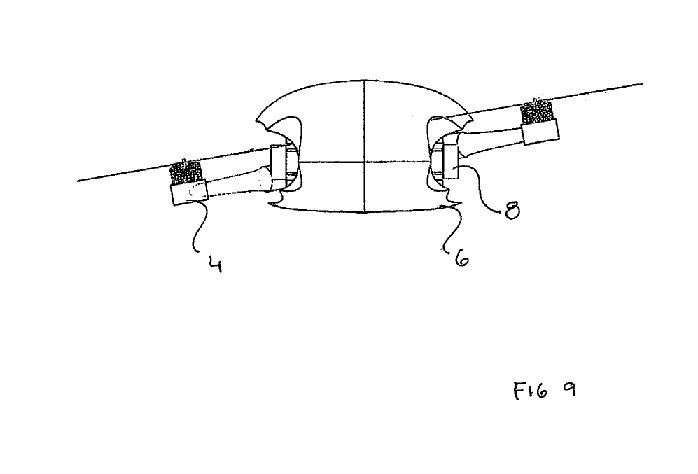

Looking at FIGS. 6 and 7 the relational dynamics between the propulsion unit's orientation, the gimbal assembly 8 and the payload housing's orientation can best be explained. With the pivotable connected structure detailed above, the propulsion unit 4 is connected to the payload housing 6 yet capable of independent orientation. The axis of rotation of the pitch motor 30, the axis of rotation of the two roll motors 32 and the axis of rotation of the yaw motor 34 all intersect at the center of mass of the gimbal assembly 8, the center of mass of the propulsion unit 4 and the center of mass of the payload housing 6. (This is also the center of mass of the drone.) With the payload housing having the heavier mass, any rotational torque of the pitch, roll and yaw motors will rotate the first portions of their motors (which are directly connected to the lighter propulsion unit 4 via the pitch motor 22 or indirectly connected to the lighter propulsion unit 4 via the gimbal frame 28), resulting in rotational (pivotal) movement of the propulsion unit 4. To further this effort, all mass not necessary to be located on the propulsion unit 4 for operation, is located to the payload housing 6.

Because the three axes of rotation intersect at the center of mass of the drone and because all three of its three components (the propulsion unit 4, the payload housing 6 and the gimbal assembly 8) all have their centers of mass located at the same common point (at the center of mass of the drone), the drone is balanced. With the propulsion unit 4 having the lowest mass of the three components, any torque applied by the gimbal motors will move the propulsion unit 4. Further, the torque required to be applied to orientate the propulsion frame 4, will be the minimal amount of torque needed to accomplish movement of the propulsion unit since the movement lies as close as possible to the X, Y or Z axes of rotation of the gimbal assembly.

In the preferred embodiment there is but one gimbal controller IMU 44 and it is internal to the gimbal controller 20 although in alternate embodiments the gimbal controller 20 may utilize multiple gimbal IMU sensors 44 located about the payload housing 6 but may also include one or more IMU sensors on the propulsion frame 4. The gimbal controller 20 is mounted in the payload housing 6.

The gimbal assembly described herein has brushless motors with a first portion and a second portion, a battery, a gimbal controller, a gimbal IMU, a gimbal frame and the operational wiring. It can take on a multitude of different designs and incorporate various numbers of gimbal motors. Basically it is a three-axis stabilization and anti-vibration device. Basically the gimbal controller 20 is a micro electro mechanical system (MEMS) with a microprocessor that takes an electronic signal obtained from a mechanical force exerted on its IMU sensor/s and generates a signal fed to gimbal motors many times each second that stabilizes the drone.

The gimbal controller has at least one IMU sensor (internal or external) located on the payload housing that senses payload housing shift during turning maneouvers, or changing wind conditions. The motor controller has at least one IMU sensor (internal or external) located on the propulsion unit that senses the positions of the various motor assemblies.

The gimbal assembly 8 as well as the propulsion unit 4 are generally powered by a common rechargeable Lithium Polymer (LiPo) or Lithium-Ion (L-iON) battery. These batteries represent a considerable percentage of the drone's total mass and are located in the payload housing 6.

In operation, as the propulsion unit's motor controllers generate signals to adjust the speed of the various engine assemblies in response to commands from the autopilot or the remote controller, the propulsion unit 4 gyrates about its center of mass (which is the located at the intersection of the center of mass of the payload housing 6 and the gimbal assembly 8) and changes the speed and/or direction of the drone 2. As this occurs, because of inertial effects, the payload and payload housing's orientation will shift. The gimbal assembly's orientation sensor (IMU) will quickly detect any pitch, roll or yaw movement of the payload housing and signal the gimbal controller which will generate signals to the appropriate pitch, roll or yaw gimbal motor/s to re-orient the gimbal assembly 6 and adjust the propulsion unit 4 such that irrespective of the propulsion unit's orientation, the payload housing 6 remains stabilized on its center of gravity and level with respect to the horizon.

The importance of utilizing the novel structural of the multi horizontal rotor drone as outlined above, can be demonstrated in the following non-exclusive list of benefits:

Improved acceleration, agility and wind tolerances by stabilizing the payload and aircraft mass;

Improved top speed by stabilizing the payload and aircraft mass, allowing for aerodynamic canopy and lifting surfaces;

Allows for omni-directional data capture through the stabilized payload housing;

Allows for live transmission of multi-lens and multi-sensor arrays by stabilizing the entire payload housing and enabling mounting of sensors around the payload housing;

Improved drone efficiency by stabilizing the payload;

Safer autonomous operations by allowing for stabilized landings as the landing gear is mounted to the stabilized portion of the airframe;

Reduced antenna shadowing as the antennas stay fixed in orientation on stabilized frame;

Reduced need for buffering and filtering of vibrations from aircraft movements as the flight electronics are mounted to the stabilized payload housing.

Lastly, the payload housing is designed to be a lifting surface for forward flight further improving the efficiency of the aircraft. Minor adjustments to the pitch of the drone would then change the angle of attack of this lifting surface. Currently no multi-rotor aircraft are designed in this way to improve on the efficiency of flight while providing a stable platform for the payload.

Although discussed as a balanced drone above, in alternate embodiments it is envisioned wherein because of physical size and other geometric barriers to complete alignment of the intersections of the three axes of rotation for the propulsion unit 4, the payload housing 6 and the gimbal assembly 8 may not coincide for all three of the components. Here, the center of mass and intersection of the three axis of rotation for the gimbal assembly may only coincide with the center of mass and intersection of the three axis of rotation for one of the other two components. Although not optimal, this type of configuration will still represent an improvement in handling, stability and energy consumption over convention drones.

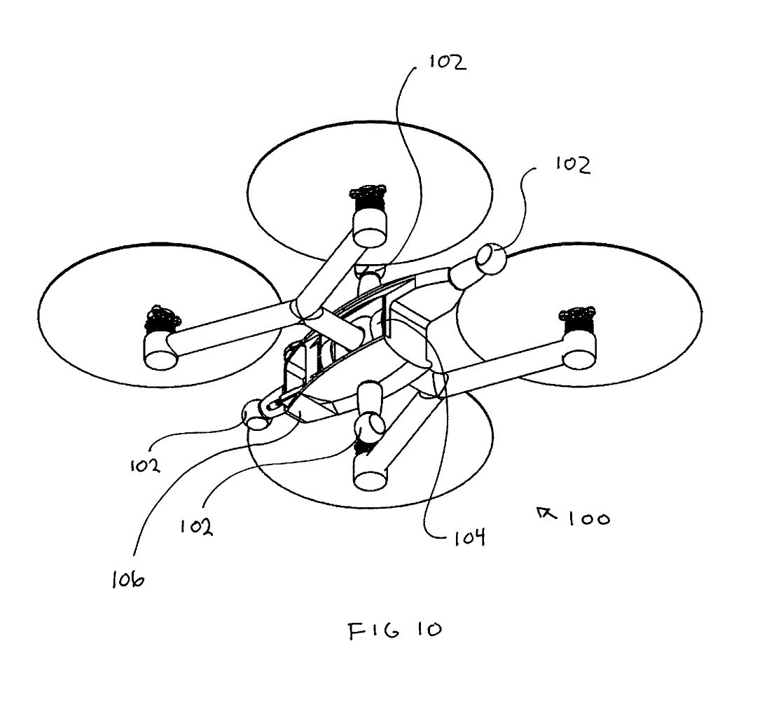

Looking at FIGS. 10 -12 the alternate embodiment optimally stabilized multi rotor aircraft can best be seen. In this alternate embodiment drone 100 there are multiple cameras 102 strategically affixed to the exterior of its payload housing 106. These cameras 102 counterbalance each other on the payload housing such that the center of mass of the payload housing remains identical centered in its geometric center regardless of whether the cameras are attached or not.

In the alternate embodiment drone, a bi-axial gimbal assembly 104 is used to compensate for pitch and roll wherein the yaw stabilization (generally to compensate for wind drift) is accomplished with the rotors.

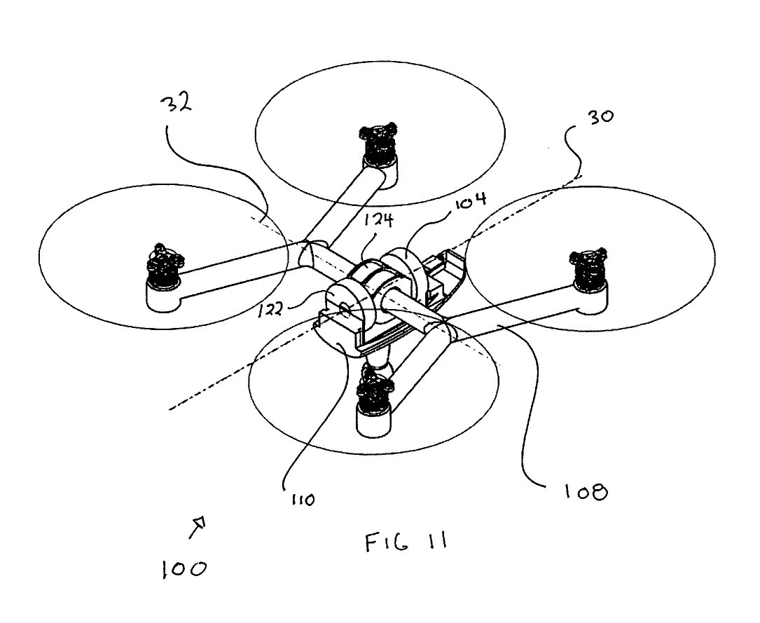

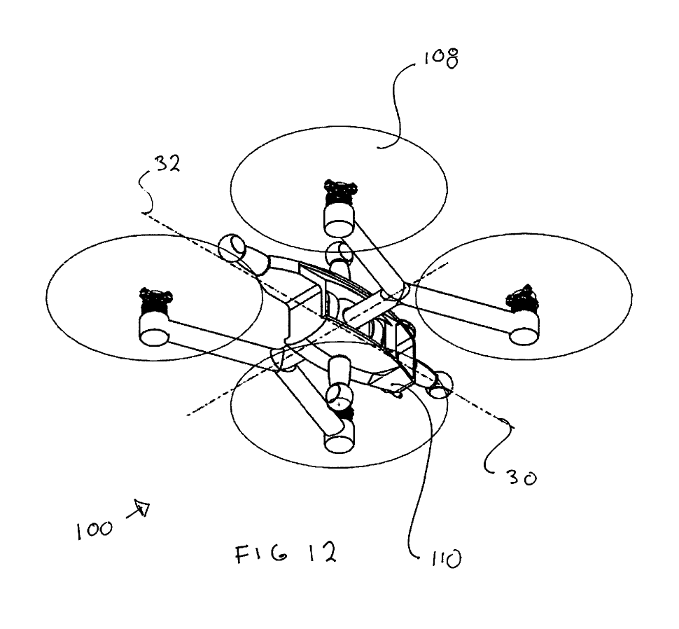

The alternate embodiment drone 100 is also a three component, multi horizontal rotor drone where the lifting system of motors and rotors (a rigid propulsion unit 108) is separated from the body of the drone (a rigid payload housing 110) by a bi-axial gimbal assembly 104 (two gimbals coupled through a gimbal frame). In this novel design, the centers of mass for the components coincide and resides at the intersection of the pitch and roll axes of the bi-axial gimbal assembly 104. The pitch axis 30 and the roll axis 32 of alternate embodiment drone 100 are visible in FIGS. 11 and 12. Similar to the preferred embodiment the gimbal 104 has a roll motor 122 and a pitch motor 124 to manage the drone's stability. (The designations of pitch and roll may be interchanged as the pitch and roll axes lie in the same plane but 90 degrees apart.)

All unnecessary mass on the propulsion unit is relocated onto the payload housing, leaving the propulsion unit much lighter than the payload unit.

The lighter propulsion unit is the component of the drone that has its orientation independently adjusted by the gimbal assembly to effect changes in pitch and roll experienced by the heavier payload housing caused by changes in direction, speed and elevation of the propulsion unit or by the entire drone in response to environmental conditions. The payload housing is thus stabilized on its center of gravity and is independent of the roll and pitch changes undergoing by the propulsion unit, needed to maintain flight.

It is to be noted that this concept of the centers of mass for the components of a manned aircraft (multi rotor or fixed wing style) coinciding and residing at the intersection of the pitch, roll and yaw axes of a gimbal assembly (or of the pitch and roll axes) is equally feasible although not discussed in detail herein.

While certain features and aspects have been described with respect to exemplary embodiments, one skilled in the art will recognize that numerous modifications are possible.

While the procedures of the methods and processes for building, assembling and using the devices described herein are described in a particular order for ease of description, unless the context dictates otherwise, various procedures may be reordered, added, and/or omitted in accordance with various embodiments. Moreover, system components described according to a particular structural architecture and/or with respect to one system may be organized in alternative structural architectures and/or incorporated within other described systems. Hence, while various embodiments are described with-or without-certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

Having thus described the invention, what is claimed as new and desired to be secured by Letters Patent is as follows:

1. A multi horizontal rotor drone, comprising:
a propulsion unit;
a payload housing;
a multi-axial gimbal assembly operationally connected between said propulsion unit and said payload housing, providing payload housing stabilization compensation for at least pitch and roll movements experienced by said said payload housing.

2. The multi horizontal rotor drone of claim 1 further comprising:
a propulsion unit center of mass;
a payload housing center of mass; and
wherein said propulsion unit center of mass and said payload housing center of mass are common.

3. The multi horizontal rotor drone of claim 1 further comprising:
a payload housing center of mass;
said multi-axial gimbal assembly with at least a pitch axis of rotation and a roll axis of rotation; and
wherein said pitch axis of rotation and said roll axis of rotation intersect at a point common with said payload housing center of mass.

4. The multi horizontal rotor drone of claim 1 further comprising:
a propulsion unit center of mass;
wherein said multi-axis gimbal assembly has a pitch axis of rotation and a roll axis of rotation; and
wherein said pitch axis of rotation and said roll axis of rotation intersect at a point common with said propulsion unit center of mass.

5. The multi horizontal rotor drone of claim 1 further comprising:
a center of mass for said drone;
said multi-axis gimbal assembly with at least a pitch axis of rotation and a roll axis of rotation ;
wherein said pitch axis of rotation and said roll axis of rotation intersect at a point common with the center of mass of said drone.

6. The multi horizontal rotor drone of claim 1 further comprising:
a tri-axial gimbal center of mass;
a propulsion unit center of mass;
a payload housing center of mass; and
wherein said tri-axial gimbal center of mass, said propulsion unit center of mass and said payload housing center of mass reside at a common point.

7. The multi horizontal rotor drone of claim 1 wherein said gimbal is housed within said payload housing.

8. The multi horizontal rotor drone of claim 1 wherein said multi axial gimbal assembly is a tri-axial gimbal assembly, operationally connected between said propulsion unit and said payload housing, providing payload housing stabilization compensation for pitch, roll and yaw movements experienced by said payload housing.

9. The multi horizontal rotor drone of claim 8 further comprising:
a propulsion unit center of mass;
a payload housing center of mass; and
wherein said propulsion unit center of mass and said payload housing center of mass are common.

10. The multi horizontal rotor drone of claim 8 further comprising:
a payload housing center of mass;
said tri-axial gimbal assembly having a pitch axis of rotation, a roll axis of rotation and a yaw axis of rotation; and
wherein said pitch axis of rotation, said roll axis of rotation and said yaw axis of rotation intersect at a point common with said payload housing center of mass.

11. The multi horizontal rotor drone of claim 8 further comprising:
a propulsion unit center of mass;
a gimbal assembly with a pitch axis of rotation, a roll axis of rotation and a yaw axis of rotation; and
wherein said pitch axis of rotation, said roll axis of rotation and said yaw axis of rotation intersect at a point common with said propulsion unit center of mass.

12. The multi horizontal rotor drone of claim 8 further comprising:
a center of mass for said drone;
said tri-axial gimbal assembly having a pitch axis of rotation, a roll axis of rotation and a yaw axis of rotation; and
wherein said pitch axis of rotation, said roll axis of rotation and said yaw axis of rotation intersect at a point common with said center of mass for said drone.

13. The multi horizontal rotor drone of claim 2 further comprising:
a gimbal assembly with a pitch axis of rotation, a roll axis of rotation and a yaw axis of rotation; and
wherein said pitch axis of rotation, said roll axis of rotation and said yaw axis of rotation intersect at a point common with the center of mass of said drone, said propulsion unit center of mass and said payload housing center of mass.
